(19) United States
(12) Patent Application Publication
(10) Pub. No.: US 2004/0015382 A1
(43) Pub. Date: Jan. 22, 2004

(54) Data-driven management decision tool for total resource management

(76) Inventors: Dennis M. Baca, Gainesville, VA (US); Michael J. Fanning, Silver Spring, MD (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/362,093

(22) PCT Filed: Sep. 6, 2001
(86) PCT No.: PCT/US01/27566

(51) Int. Cl. G06F 17/60

(52) U.S. Cl. 705/8; 705/10

(57) ABSTRACT

A method for making data-driven management decisions for use in total resource management including input of decision data and system state data into various evaluation stages. The cost associated with each evaluation stage is calculated and the total costs is determined based on the aggregate of the costs from each evaluation state. A sensitivity analysis can be performed by altering the decision data input into each evaluation stage.

### RELATED APPLICATIONS

This application is based upon and claims the benefit of priority from the prior U.S. Provisional Application No. 60/230,793 of Dennis M. Baca and Michael J. Fanning, filed Sep. 7, 2000, the contents of which are incorporated herein by reference.

### DESCRIPTION

1. Field

This invention relates to systems and methods for management decision making, and, more particularly, to a data-driven management decision tool for use in total resource management processes.

2. Background

Resources management is a business practice of managing resources by analyzing the various costs and savings associated with a resource to determine the best method for using, servicing, and replacing the resource. Conventional approaches used for resource management decisions have relied on separate consideration and evaluation of a number of criteria, such as design, acquisition, deployment, operations and maintenance, and investment recovery. The design criterion deals with the construction of the resource, such as ergonomics and possible litigation linked to flaws in the construction of a resource. Acquisition deals with the method of acquiring the resource, such as purchase or lease. Deployment deals with the method in which the resource will be implemented, such as location and storage space. Operations and maintenance deals with the manner in which the resource will be serviced. Investment recovery deals with determining the profitable method for implementing the resource.

Heretofore, investment recovery has often been the sole criterion by which total resource management decisions have been made. The most common method for measuring the investment recovery for a resource is determining the Net Present Value (NPV) and Return on Investment (ROI) of the resource. NPV is a value used in evaluating resources, whereby the net present value of all cash outflows (such as the cost of the resource) and cash inflows (such as profits generated by the resource) is calculated using a given discount rate, usually the required rate of return. An investment is acceptable if the NPV is positive. ROI is a profitability measure that evaluates the performance of a business. ROI is closely related to NPV. ROI is the interest rate corresponding to a 0 (zero) NPV. Current methods of resource management fail to consider investment recovery in combination with other factors such as design, acquisition, deployment, and operations and maintenance.

However, as demonstrated by the principles disclosed herein, investment recovery is a stage of total resource management analysis. It is dependent upon previous decisions; hence, investment recovery should not be used as the driver for the total resource management process. Total resource management is based on a combination of investment recovery and other key factors.

### SUMMARY

Accordingly, the present invention is directed to a multistage evaluation system and method which substantially obviates one or more of the limitations and disadvantages of the related art.

The advantages and purposes of the invention will be set forth in part in the description which follows, and in part will be obvious from the description, or may be learned by practice of the invention. The advantages and purpose of the invention will be realized and attained by means of the elements and combinations particularly pointed out in the appended claims.

To attain the advantages and in accordance with the purposes of the invention as embodied and broadly described herein, one embodiment of the invention is directed to a system and method for making data-driven management decisions for use in total resource management, which comprises inputting data into one or more evaluation stages, determining the cost associated with each evaluation stage based on the data input into each stage, and determining a total cost based on the aggregate of the costs of each evaluation.

It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate a presently preferred embodiment of the invention and, together with the description, serve to explain the principles of the invention. In the drawings:

FIG. 1 illustrates a flow diagram of a method consistent with the present invention;

FIG. 2 illustrates a system for performing a method consistent with the present invention;

FIG. 3 illustrates steps of a multistage evaluation process using a TRMS Decision Tool consistent with the present invention;

FIG. 4 illustrates a sample screen shot of a program performing a data input step consistent with the present invention;

FIG. 5 illustrates a sample screen shot of a program performing a data analysis step consistent with the present invention;

FIG. 6 illustrates a sample screen shot of a program performing an assumption step consistent with the present invention;

FIG. 7 illustrates a sample screen shot of a program performing a base case results display step consistent with the present invention;

FIGS. 8-13 illustrate sample screen shots of a program displaying graphical representations of results consistent with the present invention;

FIG. 14 illustrates a sample screen shot of a program performing a sensitivity analysis data entry step consistent with the present invention;

FIG. 15 illustrates a sample screen shot of a program performing a sensitivity analysis display step consistent with the present invention;

FIGS. 16-19 illustrate sample screen shots of a program displaying graphical representations of sensitivity results consistent with the present invention.

### DESCRIPTION OF THE EMBODIMENTS

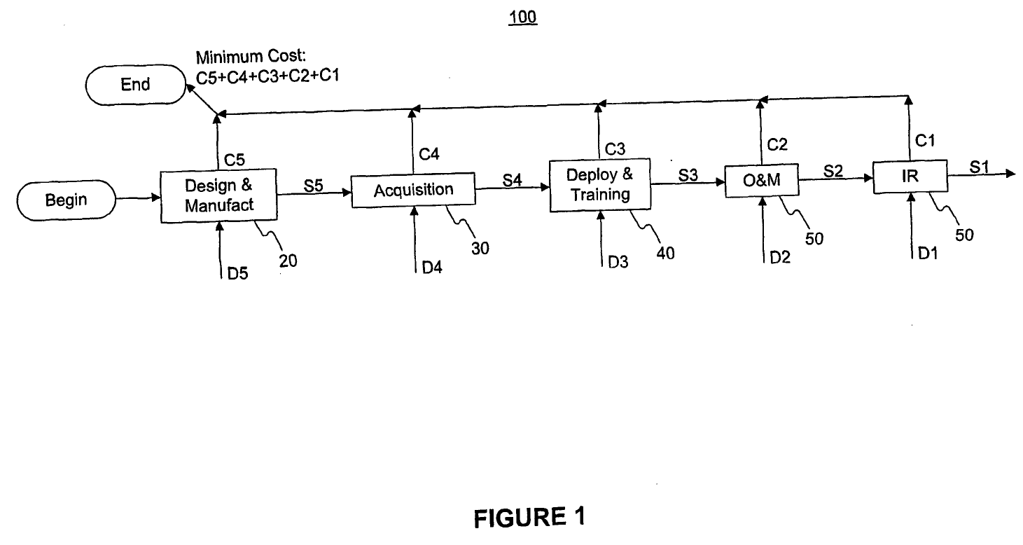

Reference will now be made in detail to an embodiment consistent with the invention, as illustrated in the accompanying drawings. As shown in FIG. 1, a data-driven management decision tool for total resource management comprises a series of cross-functional stages which together form a multistage evaluation system 100. In the disclosed embodiment, the individual stages include a design and manufacturing stage 20, an acquisition stage 30, a deployment and training stage 40, an operations and maintenance stage 50, and an investment recovery stage 60.

At each stage, relevant input data, such as financial parameters relating to the activity defined at each stage, is input. In one embodiment, the financial parameter input into each stage can be classified as one of two types: decision variables and assumptions. For example, parameters such as asset life, deposition method, acquisition method, environmental material/liability, ergonomic design/litigation, and maintenance practices are typical decision variables. Parameters such as asset design life, discount rate of Net Present Value (NPV) calculation, interest rate for leasing asset, escalation rate for replacement equipment, escalation rate for labor, escalation rate for energy, escalation rate for miscellaneous items, labor rates, rate of technological advancement, and rollover of depreciation from an asset being replaced are typical of assumptions. Decision variables and assumptions can be further divided into sub-categories. For example, rollover of depreciation from an asset being replaced can be broken down into sub-categories including depreciation remaining, acquisition cost of replaced asset, salvage value of replaced asset, depreciation life of replaced asset, and method of depreciation.

As shown in FIG. 1, a process consistent with the present invention starts with an input to a design and manufacturing stage 20, which is fed with any previously-determined decision data D5 as well as any previously-determined system state data (not shown). A first output from design and manufacturing stage 20 is a parameter S5, representing the state of the system resulting from design and manufacturing stage 20. Parameter S5 is input into acquisition stage 30. Acquisition stage 30 also receives input D4, representing decision data made for stage 4. A first output from acquisition stage 30 is a parameter S4, representing the state of the system resulting from acquisition stage 30. Parameter S4 is input into deployment and training stage 40, which also receives a data input, D3, representative of decision data for stage 3. Similarly, an output parameter, S3, from deployment and training stage 40, is input into operations and maintenance stage 50. Operations and maintenance stage 50 is also inputted with D2, representative of decision data for stage 2. Lastly, investment recovery stage 60 receives an output parameter, S2, from operation and maintenance stage 50 and a data input, D1, representative of decision data for stage 1. Additional outputs C5, C4, C3, C2 and C1 are taken, respectively, from design and manufacturing stage 20, acquisition stage 30, deployment and training stage 40, operations and maintenance stage 50 and investment recovery stage 60. The sum of C5+C4+C3+C2+C1 is a minimum overall cost.

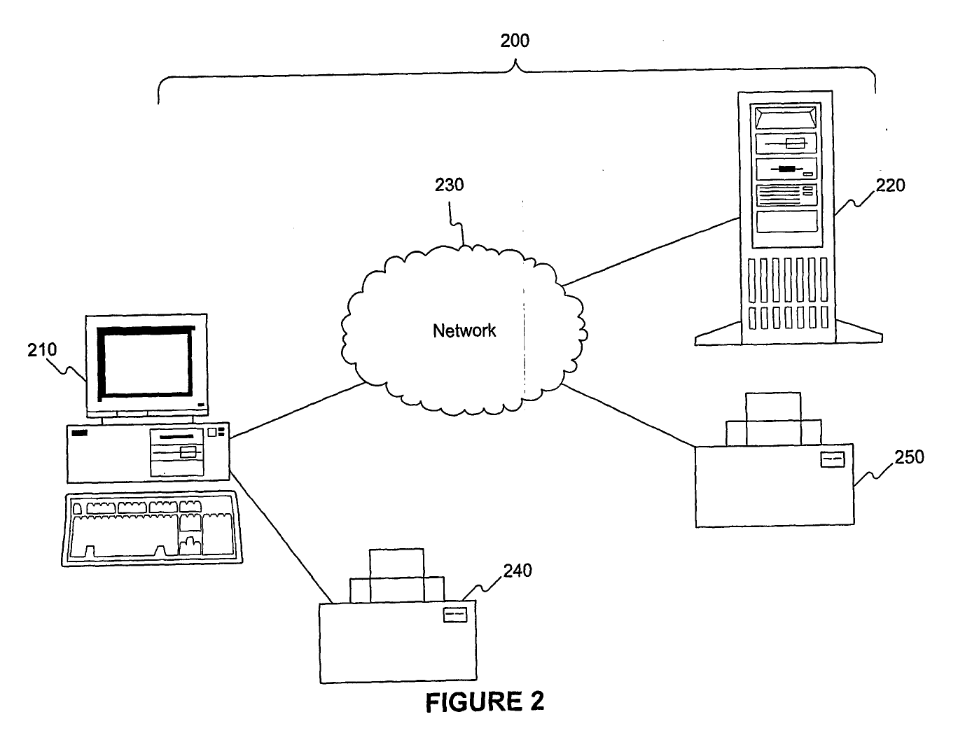

A system on which the above method may be performed will now be described with reference to FIG. 2. The multistage evaluation system 200 consists of a computer system 210. Computer system 210 comprises a monitor, keyboard, and computer unit. The computer unit contains the standard components required for inputting, outputting, manipulating, and storing data. For example, the computer unit may be comprised of a central processing unit (CPU), random access memory (RAM), video card, sound card, magnetic storage devices, optical storage devices, input/output (I/O) terminals, and a network interface card (NIC). Computer system 210 can optionally be connected to a printer 240 through the I/O terminals. Examples of the I/O terminals to which the printer can be connected are parallel, serial, universal serial bus, and IEEE 1394. Also, if computer system 210 contains an NIC card, the system can be optionally connected to remote computing devices through a network 230. For example, network 230 can be a local area network (LAN), wide area network (WAN), or wireless network. Examples of remote computing devices to which computer system 210 may be connected are a remote server 220 and a remote printer 250.

A multistage evaluation process consistent with the present invention may be performed on the multistage evaluation system 200. The different steps performed by the stages of the evaluation system may be performed by, for example, a computer program or a financial spreadsheet. A computer program consistent with the present invention may be created using various programming languages or software suites. For example, the computer program can be a stand alone program coded in a language such as Java™ or C++, or it may be designed using a known spreadsheet program.

In an embodiment of the present invention, the multistage evaluation process may be performed entirely by, for example, computer system 210. The computer program or spreadsheet for executing steps of the multistage evaluation process is stored at computer system 210. The program can be stored, for example, on one of the magnetic storage devices or optical storage devices contained in computer system 210. For example, magnetic storage devices such as hard disk drives or floppy disk drives could be used to store the computer program or spreadsheet. Also, optical storage devices such as CD-ROM, DVD, CD-R, or CD-RW could be used to store the computer program or spreadsheet. When the evaluation is ready to proceed, the computer program or spreadsheet is executed. Various parameters are inputted into the computer program or spreadsheet by an analyst using the keyboard. The program may also be linked to databases located at computer system 210. The computer program or spreadsheet can query the database for values inputted into the different stages of the multistage evaluation system.

Once all of the parameters are entered, the computer program or spreadsheet performs a multistage evaluation process. The results of the process can be displayed on the monitor of computer system 210. The results can be displayed in either numerical or graphical form. The operator can print the numerical or graphical results on printer 240.

After the initial evaluation process is complete, the computer program or spreadsheet may also perform a sensitivity analysis. The operator can change various parameters entered into the multistage evaluation system to determine what effect the change has on the results. The results of the sensitivity analysis can be displayed on the monitor of computer system 210 in numerical or graphical form. Also, the operator has the option of printing a hard copy of the results of the sensitivity analysis on printer 240.

The method has been described as running locally on computer system 210. In another embodiment, a remote computer system may be used in combination with computer system 210. In this embodiment, the computer program or spreadsheet is functionally the same but the location of the program, spreadsheet, or inputted data may differ. For example, instead of the computer program or spreadsheet being stored at computer system 210, the program or spreadsheet can be stored at remote server 220. In this embodiment, the computer program or spreadsheet would be stored on magnetic or optical storage devices located at remote server 220. Once the multiage stage evaluation is ready to be performed, the computer program or spreadsheet would be transferred from remote server 220 across network 230 to computer system 210 for execution. Alternately, the computer program or spreadsheet can be remotely executed at remote server 220. Also, databases containing values inputted into the multistage evaluation system can be stored at remote server 220. Once the evaluation process is performed, the results can be transferred across network 230 for display at remote server 220 or printing on remote printer 250.

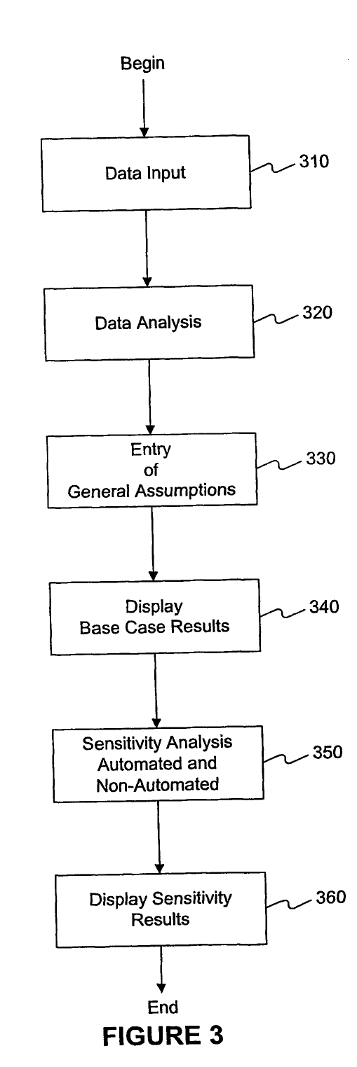

An example consistent with an embodiment of the invention will now be described with reference to FIGS. 3-19. The example concerns the analysis of the replacement of manual flat mail sorting machines with Flat Sorting Machines (FSM) 1000 Keying using the United States Postal Service Total Resource Management System (TRMS) Decision Tool. The FSM 1000 Keying is a machine for processing mail. The TRMS Decision Tool is one example of the present invention implemented using a financial spreadsheet such as Microsoft® Excel. It will be apparent to those skilled in the art using the following description how to implement the TRMS Decision Tool.

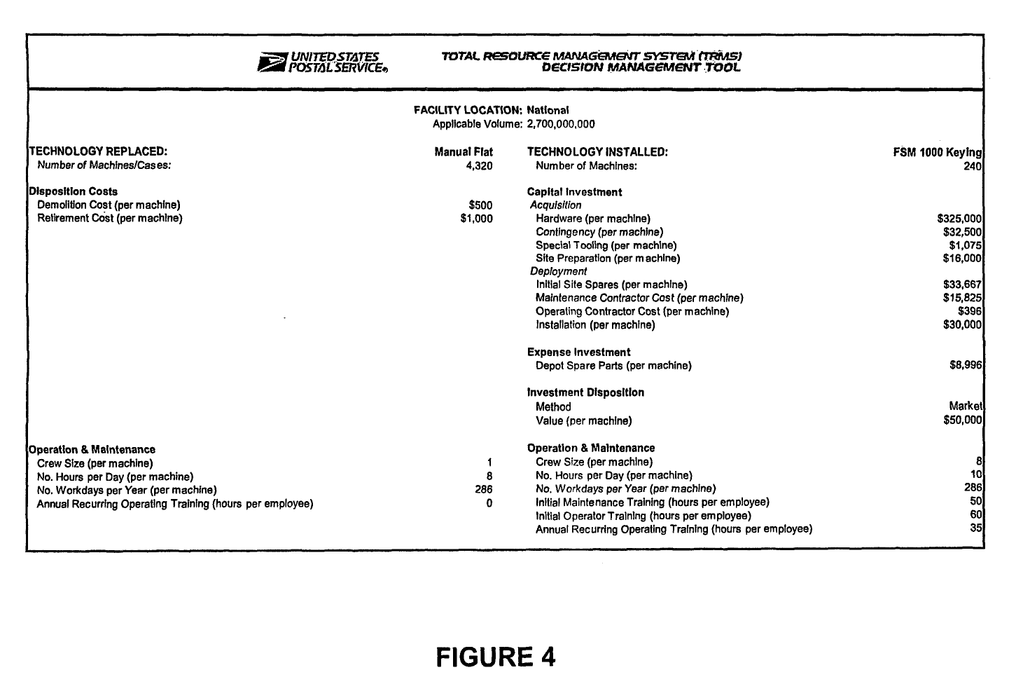

FIG. 3 is a flowchart illustrating the steps of a multistage evaluation using the TRMS Decision Tool. An analyst begins a new analysis with data input step 310 of the TRMS Decision Tool. A sample screen shot for this step is shown in FIG. 4. In step 310, the analyst provides information about the resource to be analyzed, including characteristics of the resource and of the existing capital resource that it may replace. In the mail processing equipment example, the data input step includes the specification of the existing mail processing technology and the new technology that is to be installed. The analyst provides information on various parameters concerning the old and new technologies. For example, the analyst enters the capital cost of the new technology, along with the disposition value for both the new and old technologies. The parameter values that cannot be obtained from existing databases are included on the Data Input screen of FIG. 4. The parameter values may be obtained from various entities providing services related to the parameter. For example, the demolition cost per machine would be acquired from a company performing the demolition.

The analyst also specifies the location for the resource, which will allow the TRMS Decision Tool to locate appropriate location-specific parameters in available databases. In cases where a programmatic purchase is being considered, the analyst can indicate that the location is national in scope. If it would be useful to be able to analyze regional programmatic purchases as well, that capability could easily be added to the TRMS Decision Tool.

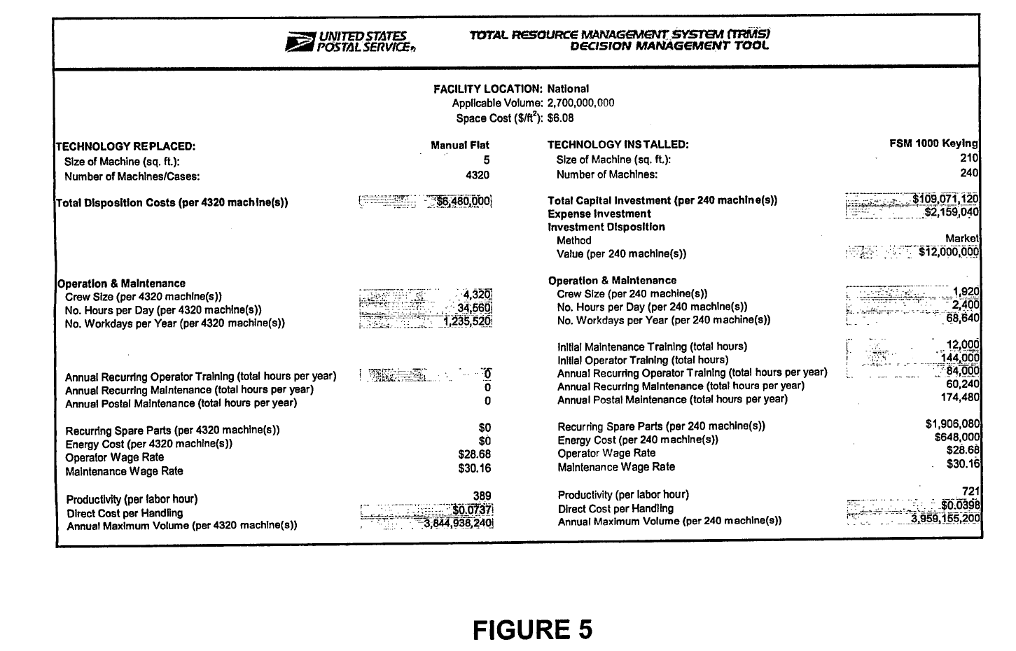

The second step is a data analysis 320. Data analysis 320 takes place with the data review screen, an example of which is shown in FIG. 5. The data review screen summarizes the technical parameters of the new and old technologies. This screen combines the information from data input step 310 with information taken from databases. In data analysis step 320, some preliminary calculations are also performed. For example, in the mail-processing example, values for the Direct Cost per Handling are calculated in data analysis step 320, using the Operator Wage Rate and the Productivity (per labor hour). The source of the information in this step can be indicated by shading on the screen, with analyst-entered indicated in white, database-derived values indicated by light shading, and calculated values indicated by heavy shading.

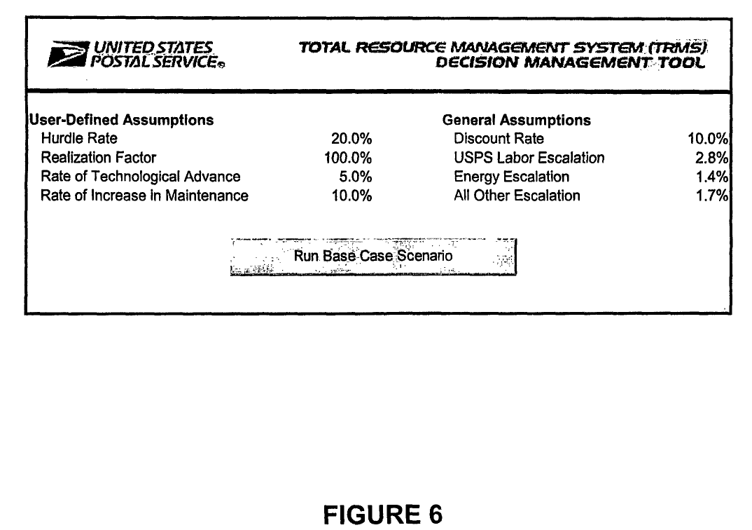

The third step of the TRMS Decision Tool analysis is an assumption step 330, an example of which is shown in FIG. 6. This screen shows the general economic assumptions that are used to perform the economic calculations of NPV and ROI. These parameters can be taken directly from a handbook that specifies how the economic analysis should be performed. These parameters include the discount and hurdle rates, along with three escalation rates for labor, energy and other costs.

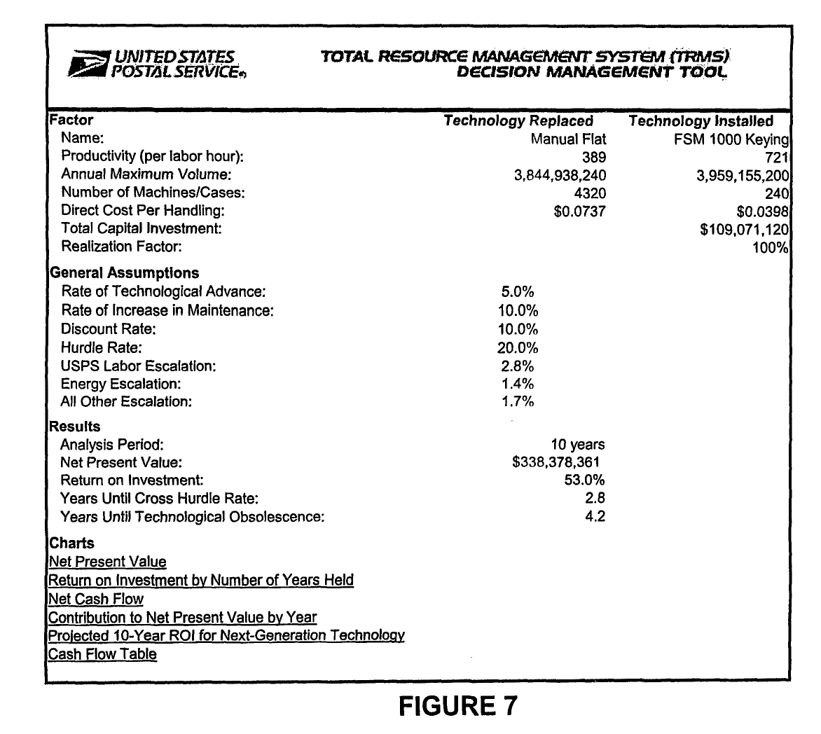

Other parameters entered in assumption step 330 may be new parameters that are being included in the TRMS Decision Tool. For example, the Realization Factor allows the analyst to specify whether the full projected savings from the new technology will be achieved. This parameter allows the analyst to consider the impact of unforeseen factors in the deployment of a new technology and to correct for levels of savings that may be overly optimistic. A second example is the Rate of Technological Advance, which allows the analyst to specify how quickly technology is changing. A third example is the Rate of Increase in Maintenance, which allows the analyst to specify how quickly maintenance costs will increase as the technology ages. For these latter two parameters, an analysis of existing data could be performed to show what range of parameter values is likely. The analyst can adjust any of these parameter assumptions on the assumptions screen shown in FIG. 6. When the analyst is finished adjusting the parameters, pressing the button marked “Run Base Case Scenario” causes the TRMS Decision Tool to produce the Base Case results and advances the analyst to a results screen as shown in FIG. 7.

The fourth step of the TRMS Decision Tool analysis is base case results step 340, an example of which is shown in FIG. 7. This screen summarizes the parameter values describing the new and old technologies, along with the general assumptions that are used in the analysis. The results section shows the results for the base case analysis of the resource evaluated using the TRMS Decision Tool. The length of the analysis is indicated by the Analysis Period output. In most cases, the analysis is performed for a 10-year period in accordance with the instructions for preparing an economic analysis. However, in cases in which the NPV peaks before 10 years—for example, if there is an especially fast increase in maintenance costs over time—, then the analysis period is reduced to the length of time that produces the maximum NPV. The results section shows the NPV and ROI corresponding to the analysis period, along with the number of years to produce an ROI equal to the hurdle rate and the number of years until the resource becomes technologically obsolete. In addition to these economic measures of payoff of the resource, the TRMS Decision Tool could also include measures of the changes in energy usage and emissions in the results section. These measures will allow the analyst to understand some of the environmental impact of the new resource that is not captured in the economic measures of NPV and ROI.

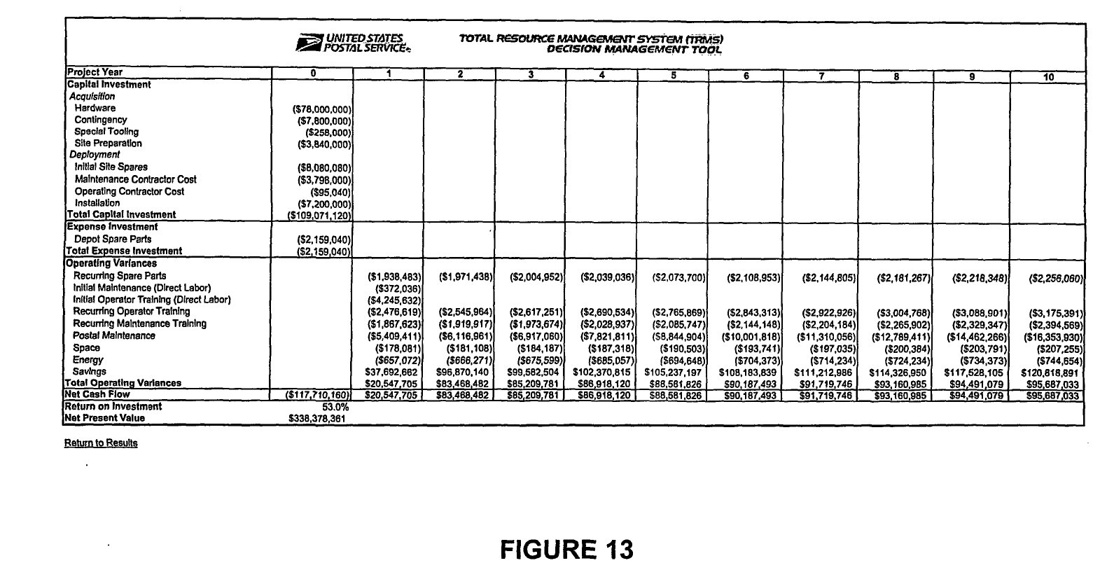

The NPV and ROI are determined by calculating the cash flow for each year up to the end year using standard accounting methods. A chart showing the cash flow for the mail processing example is described below with reference to FIG. 13. The cash flow is determined by the cash inflows and outflows inputted in the first three steps (310, 320, 330). Once the cash flow is determined, the NPV is calculated by using the imbedded NPV calculation function of the TRMS Decision Tool. The NPV for each year can be determined by the following equation:

$$NPV = {\sum }_{i = 1}^{n} \frac{{values}_{i}}{{( 1 + rate )}^{i}}$$

where n is the number of cash flow, valuesᵢ is value of a particular cash inflow or outflow, and rate is the discount rate inputted in step 330. Once the NPV is calculated for each year, the NPV for the end year of the specified time period is selected and displayed in the results. The ROI is calculated by the imbedded ROI calculation of the TRMS Decision Tool. The calculation determines the ROI for each year by calculating the interest rate corresponding to a 0 (zero) NPV. The ROI for the end year of the specified time period is selected and displayed in the result.

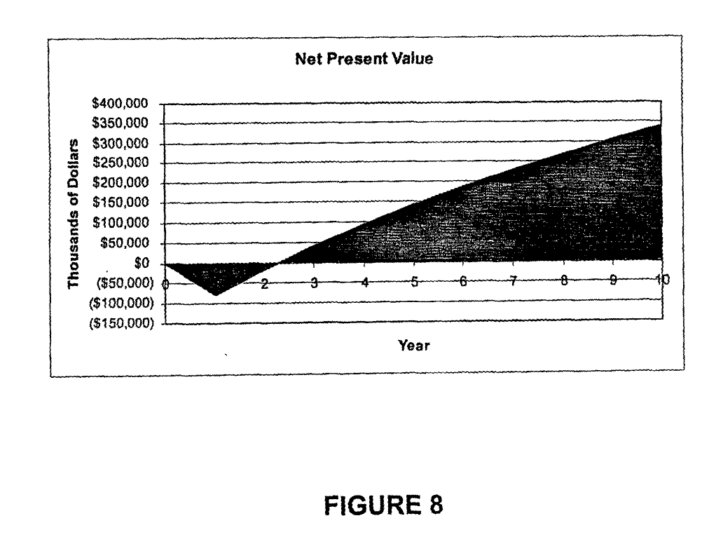

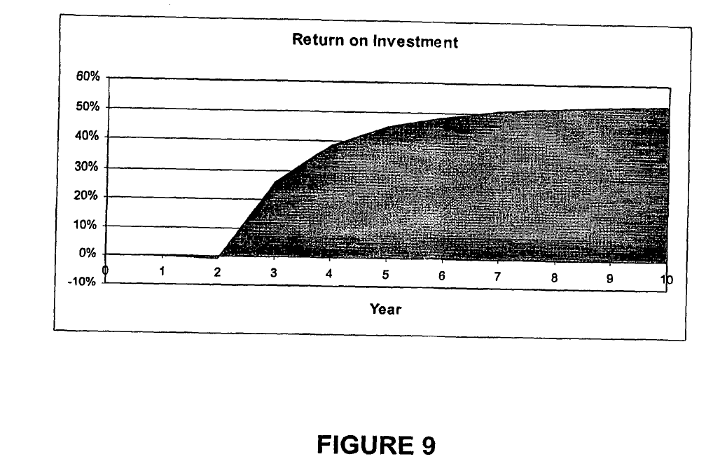

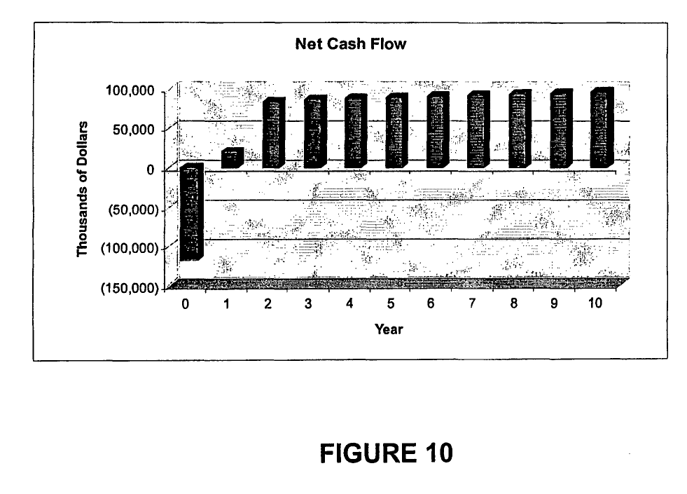

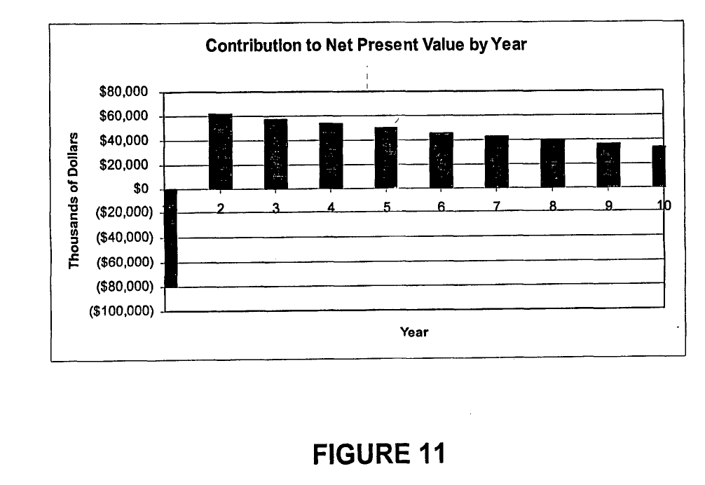

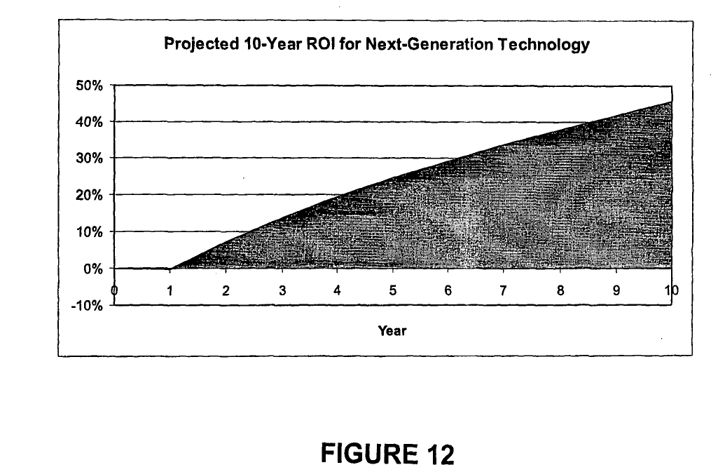

Base case results step 340 also generates a number of charts that show the results in more detail. FIGS. 8 and 9 are two sample charts showing the NPV and the ROI that result from keeping the new resource for different lengths of time up to the 10-year period specified for the analysis. FIG. 10 is a chart showing the undiscounted yearly cash flow for the new resource over a 10-year period. FIG. 11 is a chart showing how each year's cash flow contributes to the 10-year NPV of the resource. This chart illustrates how the primary NPV payoff of a new resource generally occurs in the early years of its use. FIG. 12 is a chart showing the projected 10-year ROI for the next-generation technology over the next 10 years. This chart illustrates how the economic value of the next-generation technology improves over time and eventually crosses the hurdle rate. Finally, FIG. 13 is a screen shot of a chart detailing the yearly cash flow calculation in a format that is consistent with the requirements of the invention.

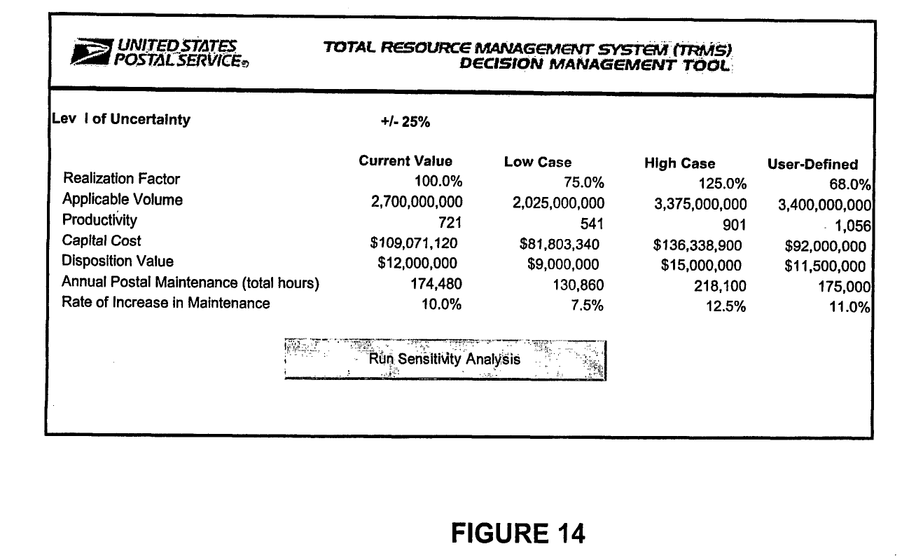

The next step of the TRMS Decision Tool analysis is a sensitivity analysis parameters entry step 350. A screen shot of a sample data entry form is shown in FIG. 14. This screen is the control panel that allows the user to define both the automated and non-automated portions of the sensitivity analysis.

In the automated portion of the sensitivity analysis, the TRMS Decision Tool automatically changes critical parameter values up and down, for example, by an equal percentage. The analyst may control the size of this percentage change by altering the value in the Level of Uncertainty field. In one example, the possible values for the Level of Uncertainty range from 10 to 30 percent. The base case parameter values are shown in the Current Value column. The Low Case column shows the parameter values after a percentage decrease from the base case, whereas the High Case column shows the parameter values after a percentage increase from the base case.

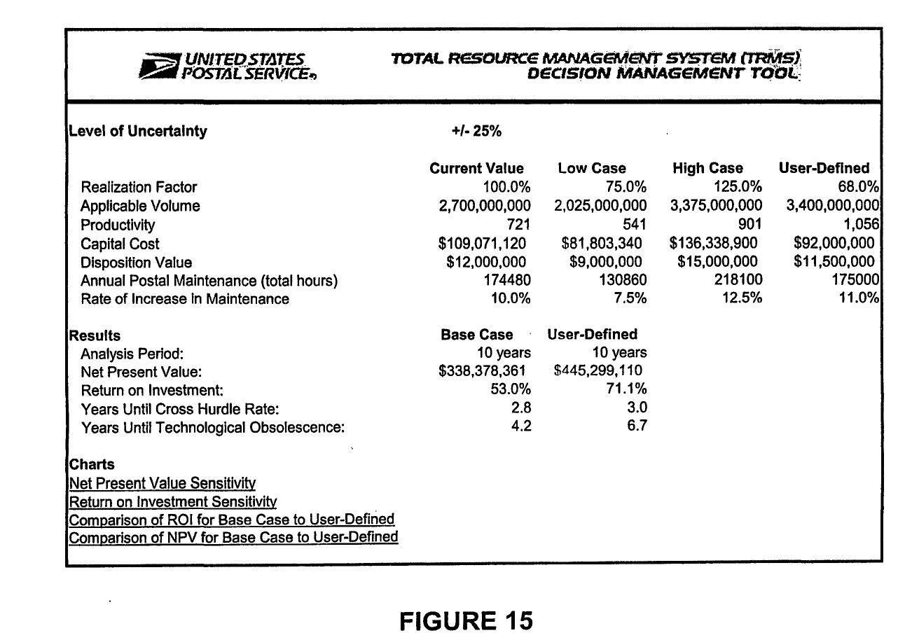

The automated portion of the sensitivity analysis may alter each of the parameter values individually, keeping all other parameter values at their base case values. Including both increases and decreases in values, this portion of the sensitivity analysis computes different scenarios to compare with the base case. These results are shown on the Sensitivity Analysis Results screen, which is described below with reference to FIG. 15. The automated portion of the sensitivity analysis allows the analyst to understand how the investment NPV and ROI calculations are affected by changes in each of these parameter values.

In the non-automated portion of the sensitivity analysis, the analyst assigns values for the parameters. These changes can be applied simultaneously, thus allowing the analyst to explore the combined effect of the parameters on the resource NPV and ROI. The non-automated parameter values are shown in the User-Defined column of the Sensitivity Analysis screen shown in FIG. 14.

When the analyst is finished adjusting the various parameters, pressing the button marked “Run Sensitivity Analysis” causes the execution of sensitivity calculation and display step 360. In step 360, the TRMS Decision Tool calculates the sensitivity analysis results and advances the analyst to the sensitivity analysis screen shown in FIG. 15, which gives the results. Note that in a typical analysis, the analyst may go back and forth several times between the Sensitivity Analysis Parameters and Sensitivity Analysis Results screens.

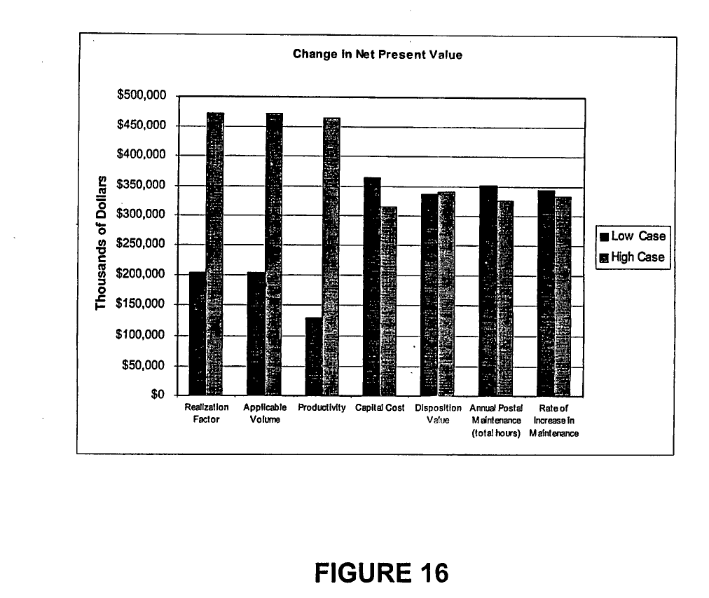

Sensitivity calculation and display step 360 of the TRMS Decision Tool analysis is shown by the Sensitivity Analysis Results screen, a sample of which is shown in FIG. 15. This screen shows the results for both the automated and non-automated portions of the sensitivity analysis. The initial screen summarizes the parameter values that were chosen in step 360, along with the non-automated analysis comparing the Base Case results with the User-Defined results. This portion of the screen also provides links to four charts, which are showN in FIGS. 16 through 19 that show the results for both the automated and non-automated portions of the analysis.

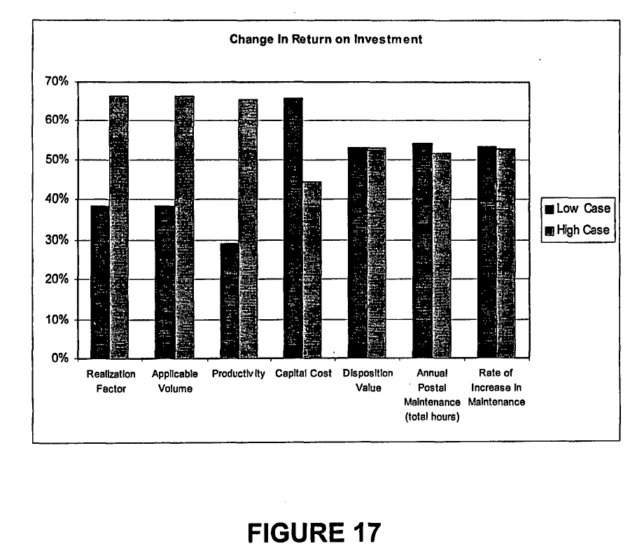

FIGS. 16 and 17 are sample charts providing the results for the automated portion of the sensitivity analysis. FIG. 16 shows the impact of the parameter value variation on the calculated NPV. For each of the parameters, the chart shows the NPV when a low value is used for the parameter and when a high value is used for the parameter. Recall that in the automated portion of the sensitivity analysis, the parameter values may be changed individually, so that the values of all parameters are at their base case value except for the one parameter that is being changed. This example shows that there is a big change in calculated NPV resulting from a 25 percent variation in the Realization Factor, the Applicable Volume, and the Productivity, but only small changes resulting from variation in the other parameters. FIG. 17 is analogous to the first chart but shows the impact of the parameter value variation on the calculated ROI rather than on the calculated NPV.

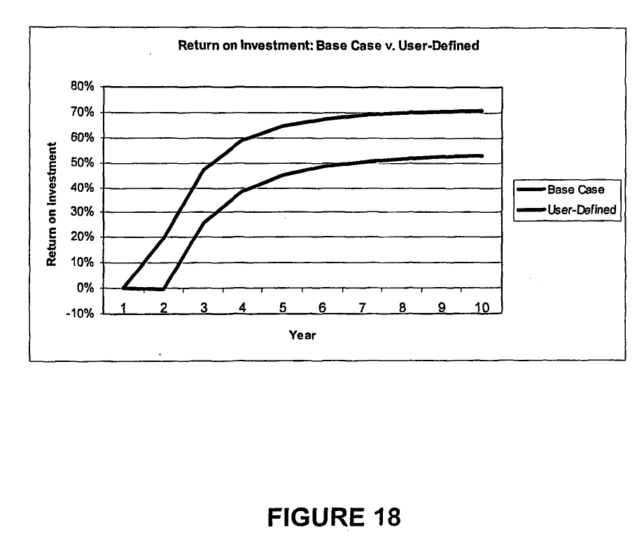

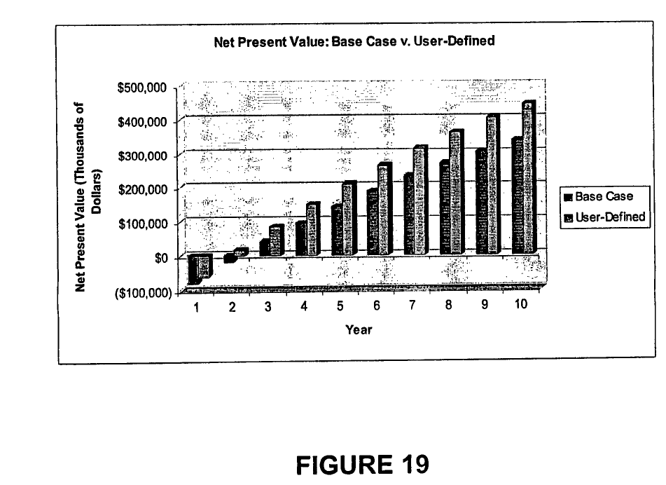

FIGS. 18 and 19 are sample charts providing further information about the non-automated portion of the sensitivity analysis. These charts compare the Base Case and User-Defined results for keeping the new resource for different lengths of time, up to the 10-year period specified the analysis. FIG. 18 shows the results for ROI, and FIG. 19 shows the results for NPV.

Systems consistent with the present invention, such as TRMS Decision Tool, provide a number of benefits to conventional resource analysis, such as the capability to automatically calculate the Net Present Value (NPV) and Return on Investment (ROI) figures that form the foundation of the economic analysis. Another improvement is the capability for conducting a sensitivity analysis on a number of the assumptions that form the foundation for the economic analysis of the resource including both automated and non-automated portions. The automated portion shows how changes to some of the critical parameters affect the resulting NPV and ROI figures. This automated analysis allows an analyst to quickly identify which parameters have the most impact on the outcome, so that these parameters can be explored in more depth. The non-automated portion of the sensitivity analysis allows the analyst to contrast two sets of parameter values directly in order to see how the differences affect the calculations of NPV and ROI.

Yet another improvement is the capability for analyzing the way that future technological change will affect the life of the current resource using information about the rate of technological improvement to project how quickly the current resource is likely to become obsolete. The result shows when replacement of the current resource is likely. This allows the analyst to determine whether the current resource is able to reach the hurdle ROI before becoming technologically obsolete.

It will be apparent to those skilled in the art that various modification and variation can be made in the method and system of the present invention without departing from the scope of the invention. Thus, it is intended that the present invention cover the modification and variation of this invention provided they come within the scope of the appended claims and their equivalents.

What is claimed is:

1. A method for making data-driven management decisions for use in total resource management, comprising:
inputting data into at least one evaluation stage;
determining a cost associated with each of the at least one evaluation stage based on the data inputted into that at least one evaluation stage; and
determining a total cost based on the aggregate of the costs of each of the at least one evaluation stage.

2. The method as set forth in claim 1, wherein the at least one evaluation stage is selected from the group consisting of design and manufacturing stage, acquisition stage, deployment and training stage, operations and maintenance stage, and investment recovery stage.

3. The method as set forth in claim 1, wherein the inputted data comprises previously determined decision data.

4. The method as set forth in claim 1, wherein the inputted data comprises previously determined data and system state data.

5. The method as set forth in claim 4, wherein the system-state data is outputted from a previous evaluation stage.

6. The method as set forth in claim 1, further comprising:
performing sensitivity analysis by changing the data inputted into the at least one evaluation stage.

7. A system for making data-driven management decisions for use in total resource management, comprising:
a means for inputting data into at least one evaluation stage, wherein the inputted data comprises previously determined data;
a means for determining a cost associated with each of the at least one evaluation stage based on the data inputted into that at least one evaluation stage;
a means for determining a total cost based on the aggregate of the costs of each of the at least one evaluation stage.

8. The system as set forth in claim 7, further comprising:
a means for outputting system state data from each of the at least one evaluation stage;
a second means for inputting the outputted system state data from a previous evaluation stage into a next evaluation stage.

9. The system as set forth in claim 7, further comprising:
a means for performing a sensitivity analysis by changing the data inputted into at least one evaluation stage.

10. A computer readable medium including instructions for making data driven management decisions for use in total resource management, the instructions comprising:
inputting data into at least one evaluation stage, wherein the inputted data comprises previously determined data;
determining cost associated with each of the at least one evaluation stage based on the data inputted into that at least one evaluation stages; and
determining a total cost based on the aggregate of the costs of each of the at least one evaluation stage.

11. The computer readable medium as set forth in claim 10, the instructions further comprising:
outputting system-state data from each of the at least one evaluation stage;
inputting the outputted system-state data from a previous evaluation stage into a next evaluation stage.

12. The computer readable medium as set forth in claim 10, the instruction further comprising:
performing a sensitivity analysis by changing the data inputted into at least one evaluation stage.

13. A method for performing total resource management comprising:
inputting resource characterization values into a determination stage;
inputting assumptions into the determination stage;
determining investment recovery values from the resource characterization inputted values and assumptions; and
outputting the investment recovery values.

14. The method according to claim 13, wherein the investment recovery values comprise a net present value and a return on investment value.

15. The method according to claim 13, wherein the assumptions are selected from a group consisting of hurdle rate, realization factor, rate of technological advance, rate of increase in maintenance, discount rate, labor escalation, energy escalation, and other escalation.

16. The method according to claim 13, further comprising:
performing a sensitivity analysis; and
outputting results of the sensitivity analysis.

17. The method according to claim 16, wherein the sensitivity analysis comprises altering at least one of the inputted assumptions.

18. The method according to claim 16, wherein the sensitivity analysis comprises altering all of the inputted assumptions.

19. A system for performing total resource management comprising:
a first means for inputting resource characterization values into a determination stage;
a second means for inputting assumptions into the determination stage;
means for determining investment recovery values from the resource characterization inputted values and assumptions; and
a first means for outputting the investment recovery values.

20. The system according to claim 19, wherein the investment recovery values comprise a net present value and a return on investment value.

21. The system according to claim 19, wherein the assumptions are selected from a group consisting of hurdle rate, realization factor, rate of technological advance, rate of increase in maintenance, discount rate, labor escalation, energy escalation, and other escalation.

22. The system according to claim 19, further comprising:
means for performing a sensitivity analysis; and
a second means outputting results of the sensitivity analysis.

23. The system according to claim 22, wherein performing means alter at least one of the inputted assumptions.

24. A system according to claim 23, wherein performing means alter all of the inputted assumptions.

25. A computer readable medium including instructions for performing total resource management, the instructions comprising:
inputting resource characterization values into a determination stage;
inputting assumptions into the determination stage;
determining investment recovery values from the resource characterization inputted values and assumptions; and
outputting the investment recovery values.

26. The computer readable medium according to claim 25, wherein the investment recovery values comprise a net present value and a return on investment value.

27. The computer readable medium according to claim 25, wherein the assumptions are selected from a group comprising: hurdle rate, realization factor, rate of technological advance, rate of increase in maintenance, discount rate, labor escalation, energy escalation, and other escalation.

28. The computer readable medium according to claim 25, the instructions further comprising:
performing a sensitivity analysis; and
outputting results of the sensitivity analysis.

29. The computer readable medium according to claim 28, wherein the sensitivity analysis comprises altering at least one of the inputted assumptions.

30. The computer readable medium according to claim 28, wherein the sensitivity analysis comprises altering all of the inputted assumptions.

31. A method for making data-driven management decisions for use in total resource management, comprising:
inputting system state data into a design and manufacture stage;
inputting decision data, D5, into the design and manufacture stage;
determining a cost, C5, and system state data, S5, for the design and manufacture stage;
outputting C5 and S5;
inputting S5 into an acquisition stage;
inputting decision data, D4, into the acquisition stage;
determining a cost, C4, and system state data, S4, for the acquisition stage;
outputting C4 and S4;
inputting S4 into a deployment and training stage;
inputting decision data, D3, into the deployment and training stage;
determining a cost, C3, and system state data, S3, for the deployment and training stage;
outputting C3 and S3;
inputting S3 into an operations and maintenance stage;
inputting decision data, D2, into the operations and maintenance stage;
determining a cost, C2, and system state data, S2, for the operation and maintenance stage;
outputting C2 and S2;
inputting S2 into a investment recovery stage;
inputting decision data, D1, into the investment recovery stage;
determining a cost, C1, and system state data, S1, for the investment recovery stage;
outputting C1 and S1;
determining a total cost by summing the costs C1, C2, C3, C4, and C5.

32. The method according to claim 31, further comprising:
performing sensitivity analysis.

33. The method according to claim 32, wherein the sensitivity analysis comprises altering at least one of the decision data input into the stages.

34. The method according to claim 32, wherein the sensitivity analysis comprises altering all the decision data input into the stages.

35. A system for making data-driven management decisions for use in total resource management, comprising:
a first means for inputting system state data and decision data, D5, into a design and manufacture stage;
a first means for determining a cost, C5, and system state data, S5, for the design and manufacture stage;
a first means for outputting C5 and S5;
a second means for inputting, S5, and decision data, D4, into the acquisition stage;
a second means for determining a cost, C4, and system state data, S4, for the acquisition stage;
a second means for outputting C4 and S4;
a third means for inputting, S4, and decision data, D3, into the deployment and training stage;
a third means for determining a cost, C3, and system state data, S3, for the deployment and training stage;
a third means for outputting C3 and S3;
a fourth means for inputting, S3, and decision data, D2, into the operations and maintenance stage;
a fourth means for determining a cost, C2, and system state data, S2, for the operation and maintenance stage;
a fourth means for outputting C2 and S2;
a fifth means for inputting, S2, and decision data, D1, into the investment recovery stage;
a fifth means for determining a cost, C1, and system state data, S1, for the investment recovery stage;
a fifth means for outputting C1 and S1;
a sixth mean for determining a total cost by summing the costs C1, C2, C3, C4, and C5.

36. The system according to claim 35, further comprising:
a means for performing a sensitivity analysis;

37. The system according to claim 36, wherein the performing means alters at least one of the decision data input into the stages.

38. The system according to claim 36, wherein the performing means alters all the decision data input into the stages.

39. A computer readable medium including instructions for making data-driven management decisions for use in total resource management, the instructions comprising:
inputting system state data into a design and manufacture stage;
inputting decision data, D5, into the design and manufacture stage;
determining a cost, C5, and system state data, S5, for the design and manufacture stage;
outputting C5 and S5;
inputting S5 into an acquisition stage;
inputting decision data, D4, into the acquisition stage;
determining a cost, C4, and system state data, S4, for the acquisition stage;
outputting C4 and S4;
inputting S4 into a deployment and training stage;
inputting decision data, D3, into the deployment and training stage;
determining a cost, C3, and system state data, S3, for the deployment and training stage;
outputting C3 and S3;
inputting S3 into a operations and maintenance stage;
inputting decision data, D2, into the operations and maintenance stage;
determining a cost, C2, and system state data, S2, for the operation and maintenance stage;
outputting C2 and S2;
inputting S2 into a investment recovery stage;
inputting decision data, D1, into the investment recovery stage;
determining a cost, C1, and system state data, S1, for the investment recovery stage;
outputting C1 and S1;
determining a total cost by summing the costs C1, C2, C3, C4, and C5.

40. The computer readable medium according to claim 39, the instructions further comprising:
performing sensitivity analysis;

41. The computer readable medium according to claim 40, wherein the sensitivity analysis comprises altering at least one of the decision data input into the stages.

42. The computer readable medium according to claim 40, wherein the sensitivity analysis comprises altering all the decision data input into the stages.

43. A method for performing total resource management comprising:
inputting resource characterization values for a base case;
performing data analysis for the base case to produce decision data;
inputting general assumptions;
determining and outputting base case results on the basis of the decision data and the general assumptions;
performing a sensitivity analysis for the base case, wherein the sensitivity analysis comprises an automated and non-automated determination; and
outputting results of the sensitivity analysis.

44. The method according to claim 43, wherein the automated determination of the sensitivity analysis comprises:
altering one of the general assumptions;
performing the sensitivity analysis by determining new results for the base case on the basis of the altered general assumption.

45. The method according to claim 44, wherein the automated determination is performed for each general assumption.

46. The method according to claim 43, wherein the non-automated determination comprises:
altering all the general assumptions;
performing the sensitivity analysis by determining new results for the base case on the basis of the altered general assumptions.

47. The method according to claim 43, wherein the assumptions are selected from a group consisting of hurdle rate, realization factor, rate of technological advance, rate of increase in maintenance, discount rate, labor escalation, energy escalation, and other escalation.

48. The method according to claim 43, wherein the data analysis of the resource characterization values comprises:
combining the resource characterization values with previously determined data to produce the decision data.

49. The method according to claim 43, wherein the outputting of the base case results comprises:
displaying the base case results in graphical form.

50. The method according to claim 43 wherein the outputting of the sensitivity results comprises:
displaying the sensitivity results in graphical form.
